(19) United States
(12) Patent Application Publication
(10) Pub. No.: US 2026/0145916 A1
(43) Pub. Date: May 28, 2026

(54) SLINGING WORK SUPPORT SYSTEM FOR WORK MACHINE AND PROGRAM

(71) Applicant: SUMITOMO HEAVY INDUSTRIES, LTD., Tokyo (JP)

(72) Inventor: Yasuhiro YAMAMOTO, Kanagawa (JP)

(21) Appl. No.: 19/395,468

(22) Filed: Nov. 20, 2025

(30) Foreign Application Priority Data
Nov. 26, 2024 (JP) 2024-205272

(51) Int. Cl. B66C 13/46

(52) U.S. Cl. CPC B66C 13/46

(57) ABSTRACT

A slinging work support system for supporting slinging work of a suspended load includes: an imaging device configured to capture an image of the suspended load; a first display device that is visible to a work supporter who is at a position away from a slinging worker who performs the slinging work; a second display device that is visible to the slinging worker; a first input device that is used when the work supporter inputs work support information for supporting the slinging work performed by the slinging worker; and a controller including a processor and a storage device coupled to the processor, the controller configured to cause the second display device to display the work support information input via the first input device together with the image captured by the imaging device.

### CROSS-REFERENCE TO RELATED APPLICATIONS

This application is based upon and claims priority to Japanese Patent Application No. 2024-205272, filed on Nov. 26, 2024, the entire contents of which are incorporated herein by reference.

### BACKGROUND

### 1. Technical Field

The present disclosure relates to a slinging work support system for a work machine and a program.

### 2. Description of Related Art

A crane equipped with a function of supporting a crane operator who receives audio instructions from a slinging worker has been known.

### SUMMARY

A slinging work support system according to an embodiment of the present disclosure is a slinging work support system for supporting slinging work of a suspended load. The slinging work support system includes an imaging device configured to capture an image of the suspended load, a first display device that is visible to a work supporter who is at a position away from a slinging worker who performs the slinging work, a second display device that is visible to the slinging worker, a first input device that is used when the work supporter inputs work support information for supporting the slinging work performed by the slinging worker, and a controller including a processor and a storage device coupled to the processor, and configured to cause the second display device to display the work support information input via the first input device together with the image captured by the imaging device.

### BRIEF DESCRIPTION OF THE DRAWINGS

FIG. 1 is a schematic view illustrating a configuration example of the slinging work support system according to an embodiment of the present disclosure;

FIG. 2 is a block diagram illustrating the configuration example of the slinging work support system illustrated in FIG. 1;

FIG. 3 is a flowchart illustrating an example of a flow of a slinging work support process;

FIG. 4 is a view illustrating an example of a work site in which slinging work is performed;

FIG. 5 is a flowchart illustrating another example of the flow of the slinging work support process; and

FIG. 6 is a schematic view illustrating another configuration example of the slinging work support system according to the embodiment of the present disclosure.

### DETAILED DESCRIPTION

The above-described crane of the related art cannot support slinging work performed by a slinging worker at all.

According to an embodiment of the present disclosure, there is provided a slinging work support system that can support slinging work performed by a slinging worker.

Embodiments of the present disclosure will be described with reference to the drawings hereinafter. The embodiments described below do not limit the present disclosure but are illustrative. All of the features described in the embodiments and combinations of the features are not necessarily essential to the present disclosure. Throughout the drawings, the same or corresponding constituent components are denoted by the same or corresponding symbols, and redundant description may be omitted.

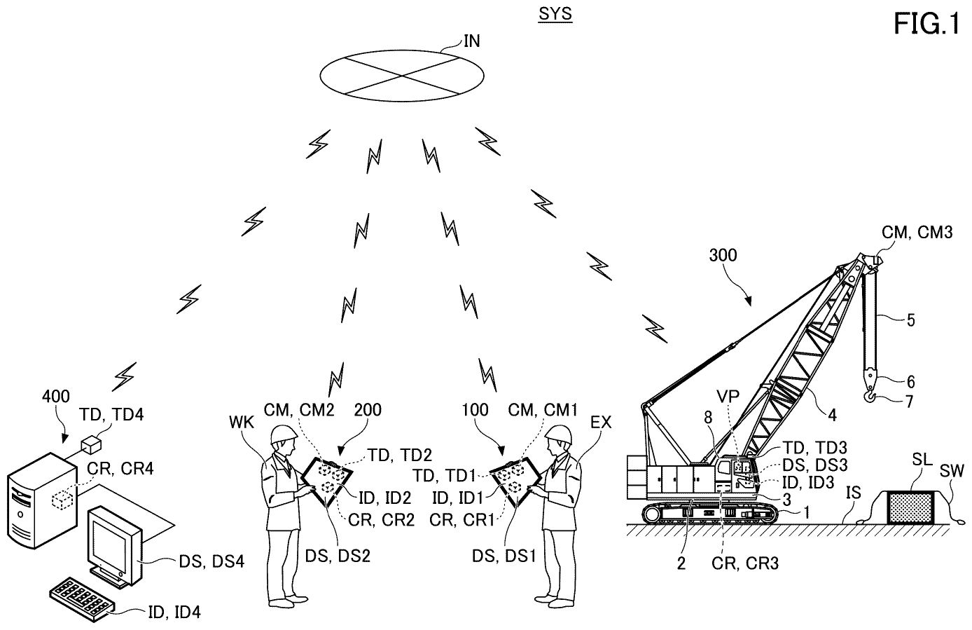

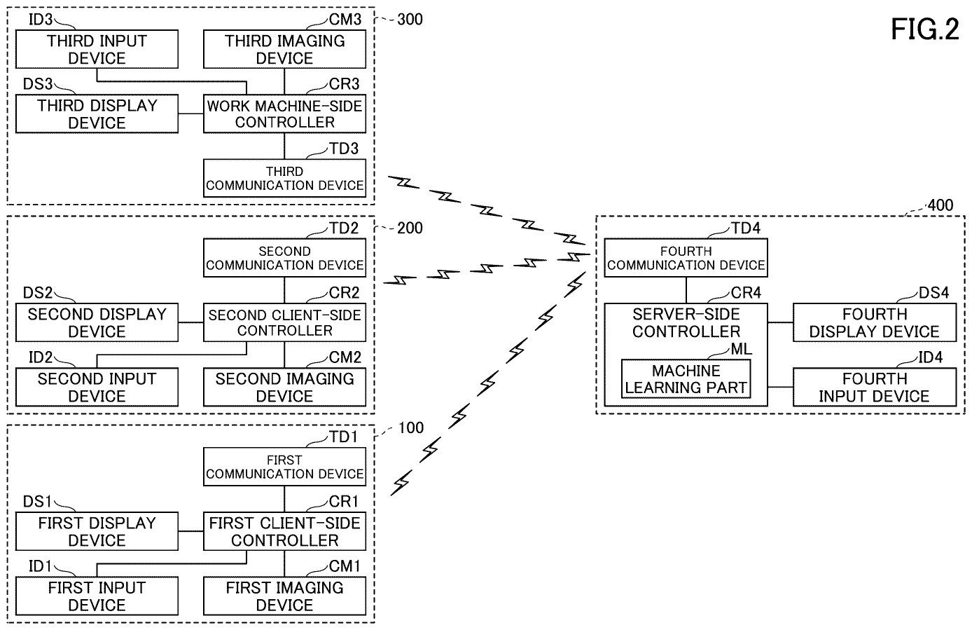

First, the slinging work support system SYS, which is a system for a work machine according to an embodiment of the present disclosure, will be described with reference to FIGS. 1 and 2. FIG. 1 is a schematic view illustrating a configuration example of the slinging work support system SYS. FIG. 2 is a block diagram illustrating the configuration example of the slinging work support system SYS.

The slinging work support system SYS is a system for supporting slinging work performed by a slinging worker WK. In the illustrated example, the slinging work support system SYS includes a first support device 100, a second support device 200, a work machine 300, and a management device 400. Each of the first support device 100, the second support device 200, the work machine 300, and the management device 400 includes a communication device TD, and the first support device 100, the second support device 200, the work machine 300, and the management device 400 are directly or indirectly connected to one another via an information communication network IN, such as a mobile phone communication network, a satellite communication network, a short-range wireless communication network, or the like. The number of each of the first support device 100, the second support device 200, the work machine 300, and the management device 400 included as constituent components of the slinging work support system SYS may be one, or two or more. In the illustrated example, the slinging work support system SYS includes one first support device 100, one second support device 200, one work machine 300, and one management device 400.

The first support device 100 is a device for supporting slinging work performed by a slinging worker WK. In the illustrated example, the first support device 100 is a portable client computer (e.g., a mobile terminal device, such as a laptop PC, a tablet PC, a smartphone, or the like) carried by a work supporter EX who is at a position away from the slinging worker WK. The first support device 100 includes a controller CR (first client-side controller CR1), an imaging device (first imaging device CM1), a display device DS (first display device DS1), an input device ID (first input device ID1), and a communication device TD (first communication device TD1). The work supporter EX is typically a skilled slinging worker, and remotely supports the slinging work performed by the slinging worker WK at a work site, from the position away from the work site. The first support device 100 may function as a server. In addition, the first support device 100 may be a wearable terminal device, such as extended reality (XR) goggles or the like.

The first client-side controller CR1 is configured to control the first support device 100. In the illustrated example, the first client-side controller CR1 is an example of processing circuitry serving as the controller CR, and is configured by a computer including a CPU, a RAM, a ROM, a non-volatile storage device, and the like. The first client-side controller CR1 reads a program corresponding to each of functional elements from the ROM, loads the program into the RAM, and causes the CPU to execute corresponding processing. However, each functional element may be configured by hardware, or may be configured by a combination of software and hardware.

In the illustrated example, the first support device 100 is a smartphone, the first imaging device CM1 is a rear-facing camera of the smartphone, the first display device DS1 is an organic EL display, and the first input device ID1 is a touch panel. The first imaging device CM1 may be an imaging device, such as a stereo camera, an RGBD camera, a LiDAR, or the like, which can measure a distance between the first imaging device CM1 and a subject to be captured. In addition, the first input device ID1 may be an audio input microphone.

The second support device 200 is a device for supporting slinging work performed by the slinging worker WK. In the illustrated example, the second support device 200 is a portable client computer (e.g., a mobile terminal device, such as a laptop PC, a tablet PC, a smartphone, or the like) carried by the slinging worker WK. The second support device 200 includes a controller CR (second client-side controller CR2), an imaging device (second imaging device CM2), a display device DS (second display device DS2), an input device ID (second input device ID2), and a communication device TD (second communication device TD2). The second support device 200 may function as a server. In addition, the second support device 200 may be a wearable terminal device, such as extended reality (XR) goggles or the like.

The second client-side controller CR2 is configured to control the second support device 200. In the illustrated example, the second client-side controller CR2 is an example of processing circuitry serving as the controller CR, and is configured by a computer including a CPU, a RAM, a ROM, a non-volatile storage device, and the like. The second client-side controller CR2 reads a program corresponding to each of functional elements from the ROM, loads the program into the RAM, and causes the CPU to execute corresponding processing. However, each functional element may be configured by hardware, or may be configured by a combination of software and hardware.

In the illustrated example, the second support device 200 is a smartphone, the second imaging device CM2 is a rear-facing camera of the smartphone, the second display device DS2 is an organic EL display, and the second input device ID2 is a touch panel. The second imaging device CM2 may be an imaging device, such as a stereo camera, an RGBD camera, a LiDAR, or the like, which can measure a distance between the second imaging device CM2 and a subject to be captured. In addition, the second input device ID2 may be an audio input microphone.

The work machine 300 is a mobile crane, and an upper slewing body 3 is slewably mounted on a crawler-type lower traveling body 1 via a slewing mechanism 2. A boom 4 is attached to the upper slewing body 3. A wire rope 5 extends downward from the tip of the boom 4, and a hook 7 is suspended from the wire rope 5 via a hook bracket 6. The hook bracket 6 includes a pulley (not illustrated), around which the wire rope 5 is wound, inside the hook bracket 6.

The imaging device CM (third imaging device CM3) is attached to the tip of the boom 4. In the illustrated example, the third imaging device CM3 is a monocular camera, and is disposed in a manner such that the third imaging device CM3 can capture an image of a space vertically below. The third imaging device CM3 may be an imaging device, such as a stereo camera, an RGBD camera, a LiDAR, or the like, which can measure a distance between the third imaging device CM3 and a subject to be captured.

The work machine 300 can lift the hook 7 to lift a suspended load SL, as the wire rope 5 is wound by a front winch (not illustrated). In addition, the work machine 300 can lower the hook 7 to lower the suspended load SL, as the wire rope 5 is unwound by the front winch.

The upper slewing body 3 is provided with a cabin 8 as an operator's cabin. In addition, the upper slewing body 3 is provided with a controller CR (work machine-side controller CR3), a display device DS (third display device DS3), an input device ID (third input device ID3), a communication device TD (third communication device TD3), and the like. The power source may be an electric motor driven by a battery or an external power supply. The work machine 300 may be a remote-controlled work machine.

The work machine-side controller CR3 is configured to control the work machine 300. In the illustrated example, the work machine-side controller CR3 is yet another example of processing circuitry serving as the controller CR, and is configured by a computer including a CPU, a RAM, a ROM, a non-volatile storage device, and the like. The work machine-side controller CR3 reads a program corresponding to each of functional elements from the ROM, loads the program into the RAM, and causes the CPU to execute corresponding processing. However, each functional element may be configured by hardware, or may be configured by a combination of software and hardware.

In the illustrated example, the third display device DS3 is an organic EL display, and the third input device ID3 is a touch panel. The third input device ID3 may be an audio input microphone.

The management device 400 is a device configured to manage operation of the work machine 300. In the illustrated example, the management device 400 is a server computer installed in a management center or the like, which is at a position away from the work site (work machine 300). The management device 400 includes a controller CR (server-side controller CR4), a display device DS (fourth display device DS4), an input device ID (fourth input device ID4), and a communication device TD (fourth communication device TD4). The management device 400 may be a portable computer (e.g., a laptop PC, a tablet PC, a smartphone, or the like).

In the illustrated example, the management device 400 is a desktop PC, the fourth display device DS4 is a liquid crystal display, and the fourth input device ID4 is a combination of a keyboard and a mouse.

The server-side controller CR4 is configured to control the management device 400. In the illustrated example, the server-side controller CR4 is yet another example of processing circuitry serving as the controller CR, and is configured by a computer including a CPU, a RAM, a ROM, a non-volatile storage device, and the like. The server-side controller CR4 reads a program corresponding to each of functional elements from the ROM, loads the program into the RAM, and causes the CPU to execute corresponding processing. However, each functional element may be configured by hardware, or may be configured by a combination of software and hardware.

The server-side controller CR4 may include a machine learning part ML. The machine learning part ML is configured to learn details of support provided by the work supporter EX through machine learning. The machine learning is, for example, machine learning using a machine learning model, such as neural network model formed using a backpropagation technique. The machine learning part ML may be implemented by at least one selected from the group consisting of the first client-side controller CR1, the second client-side controller CR2, the work machine-side controller CR3, and the server-side controller CR4, or may be implemented by another independent controller.

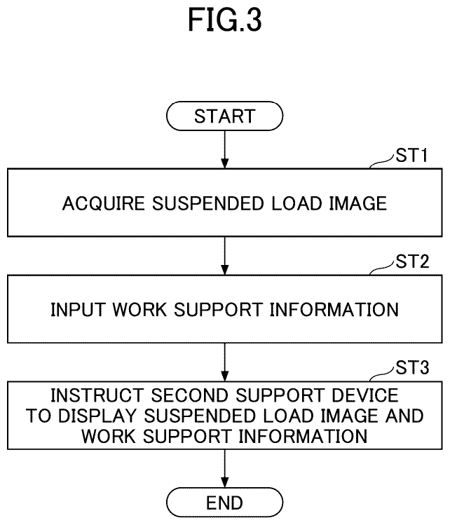

Next, an example of a flow of a process of supporting slinging work performed by a slinging worker using the slinging work support system SYS (referred to as the “slinging work support process” hereinafter) will be described with reference to FIG. 3. FIG. 3 is a flowchart illustrating an example of the flow of the slinging work support process. In the illustrated example, the first client-side controller CR1 of the first support device 100 starts a slinging work support process when a predetermined operation using the first input device ID1 is performed by the work supporter EX. In addition, the first client-side controller CR1 may start the slinging work support process when the first client-side controller CR1 receives a support request signal from the second support device 200. The second support device 200 may transmit a support request signal to the first support device 100, for example, when a predetermined operation using the second input device ID2 is performed by the slinging worker WK. The predetermined operation is, for example, an operation of touching a predetermined icon. In the illustrated example, the predetermined icon is a startup icon for starting up a slinging work support application. The predetermined operation may be an operation of pressing a predetermined hardware button, such as a work support start button, or the like, or uttering of a predetermined keyword, specifically, performing predetermined audio input.

First, the first client-side controller CR1 acquires an image of a suspended load SL (step ST1). In the illustrated example, the first client-side controller CR1 outputs an image acquisition command to the second support device 200 when the startup icon is touched. The second client-side controller CR2 of the second support device 200, which has received the image acquisition command, causes the second display device DS2 to display an initial screen of the slinging work support application, and a text image, such as “Please acquire an image of a suspended load”.

The slinging worker WK who has viewed the text image captures an image of the suspended load SL using the second imaging device CM2 mounted on the second support device 200. Thereafter, the second client-side controller CR2 that has acquired the image of the suspended load SL (suspended load image) transmits the suspended load image to the first support device 100. The suspended load image may be a still image or a moving image. The first client-side controller CR1 of the first support device 100, which has received the suspended load image, causes the first display device DS1 to display the suspended load image. The suspended load image may be an image of the suspended load SL captured from above by the third imaging device CM3 attached to the tip of the boom 4 of the work machine 300. Alternatively, the suspended load image may be an image of the suspended load SL captured by another imaging device, such as an imaging device attached to a structure installed in the work site, such as a steel tower, an imaging device attached to a flying object flying above the work site, such as a multicopter, or the like. Alternatively, the suspended load image may be any combination of multiple images captured from various viewpoints as described above.

Then, the first client-side controller CR1 encourages the work supporter EX to input work support information (step ST2). In the illustrated example, the first client-side controller CR1 causes the first display device DS1 to display a text image, such as “Please input work support information”.

The work support information is information for supporting slinging work performed by the slinging worker WK. Specifically, the work support information is a graphical image indicating a position of the center of mass (center of gravity) of the suspended load SL, a graphical image indicating a position of the suspended load SL to which one end of a sling wire SW is to be attached, a graphical image indicating a position at which a hook 7 is to be positioned, a graphical image indicating the length of the sling wire SW, or the like. The graphical image may be an icon.

The work supporter EX who has viewed the suspended load image displayed on the first display device DS1 can select a desired position in the suspended load image, for example, by touching a position on a touch panel, which serves as the first input device ID1, corresponding to the desired position in the suspended load image. The desired position in the suspended load image is, for example, a position corresponding to a center of gravity of the suspended load SL, a position at which one end of the sling wire SW is to be attached, a position at which the hook 7 is positioned, or the like. Alternatively, the work supporter EX can indicate a desired arrangement or length of the sling wire SW by tracing a desired virtual line on the suspended load image with a finger. Alternatively, the work supporter EX can select a desired range within the suspended load image by tracing a virtual circle surrounding the desired range within the suspended load image with a finger. The desired range within the suspended load image is, for example, a range corresponding to the center of gravity of the suspended load SL, a range in which one end of the sling wire SW is to be attached, a range in which the hook 7 is to be positioned, or the like. In the case where the first input device ID1 is a touchpad or a mouse, the operation of touching the touch panel with a finger is replaced with a click operation, a drag operation, or the like, which is performed while moving a cursor on the screen.

The first client-side controller CR1 enables the first display device DS1 to display the graphical image, which depicts the point touched by the finger of the work supporter EX, the line traced by the finger of the work supporter EX, or the like, as the work support information in the suspended load image displayed on the first display device DS1 in a superimposed manner.

Then, the first client-side controller CR1 instructs the second support device 200 to display the suspended load image and the work support information (step ST3) so that the slinging worker WK can view the suspended load image and the work support information displayed on the second display device DS2 of the second support device 200. The image (suspended load image and work support information) displayed on the second display device DS2 may also be displayed on the third display device DS3 or the fourth display device DS4, or both of the third display device DS3 and the fourth display device DS4. The display mode, such as a size, color, angle (in which direction the suspended load SL is viewed), or the like of the image (suspended load image and work support information) displayed on the second display device DS2 may be the same as or different from the image (suspended load image and work support information) displayed on the first display device DS1. The same applies to the image (suspended load image and work support information) displayed on each of the third display device DS3 and the fourth display device DS4.

The slinging worker WK who has viewed the suspended load image and the work support information displayed on the second display device DS2 can efficiently proceed with the slinging work using the insight of the work supporter EX who is a skilled worker. For example, in the case where the work support information indicates the position of the center of gravity of the suspended load SL, the slinging worker WK can give an instruction to an on-board operator VP of the work machine 300 so that the hook 7 is guided directly above the position of the center of gravity indicated by the work support information.

The suspended load image may be a moving image captured by the second imaging device CM2 mounted on the second support device 200. In this case, the display position of the work support information (indicating the center of gravity of the suspended load SL) set by the first support device 100 may be changed according to the change in the way the suspended load image appears, specifically, the movement of the slinging worker WK who carries the second support device 200 (second imaging device CM2). This allows the work support information to continuously indicate the position of the center of gravity of the suspended load SL. In addition, the work supporter EX may correct the display position of the work support information in real time. This is because there is a case where the position of the center of gravity of the suspended load SL may be reviewed by the work supporter EX when the work supporter EX views the suspended load image captured from another viewpoint after inputting the initial work support information. The change in the display position of the work support information on the first display device DS1 may be reflected in the display position of the work support information on the second display device DS2 in real time.

In addition, the slinging work support system SYS may be configured to always enable audio communication between the slinging worker WK, the work supporter EX, and the on-board operator VP who operates the work machine 300. Specifically, all of the first support device 100, the second support device 200, and the work machine 300 may be provided with devices that enable audio communication, such as microphones, speakers, and the like.

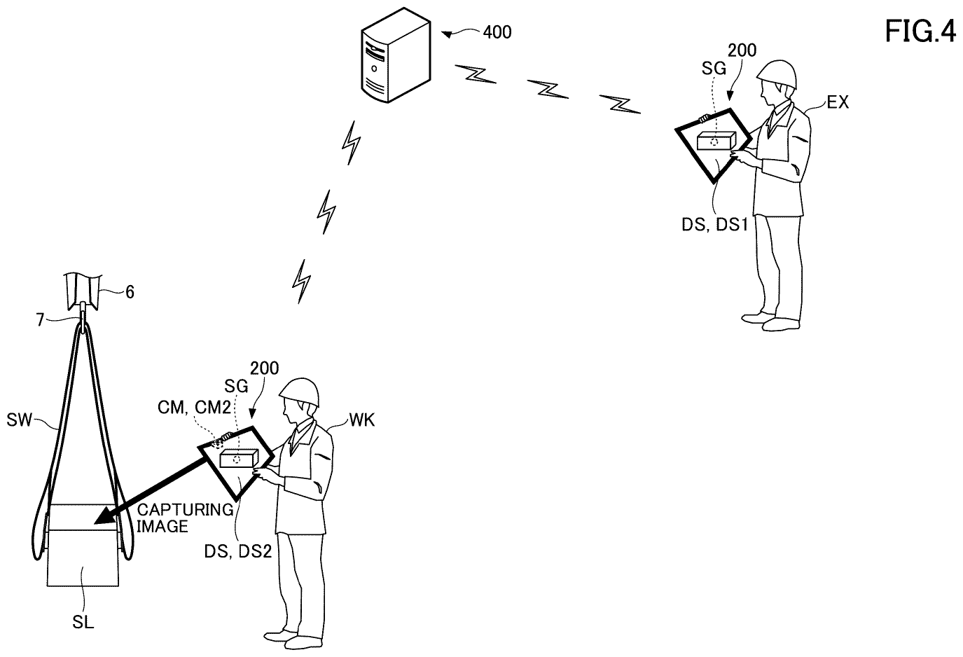

Next, a method of supporting slinging work of a slinging worker WK by a work supporter EX using the slinging work support system SYS will be described with reference to FIG. 4. FIG. 4 is a view illustrating an example of a work site at which slinging work is performed. In the example illustrated in FIG. 4, the work supporter EX supports the slinging work performed by the slinging worker WK at a remote location far away from the work site.

Specifically, in the work site illustrated in FIG. 4, the slinging worker WK is attempting to attach the sling wire SW to the suspended load SL, and the slinging worker WK is trying to check the position of the center of gravity of the suspended load SL using the second support device 200. The slinging worker WK carries a tablet PC as the second support device 200.

More specifically, the slinging worker WK is capturing an image of the suspended load SL using the second imaging device CM2 of the second support device 200. Then, the suspended load image, which is the image (captured image) captured by the second imaging device CM2, is transmitted to the management device 400. The management device 400 transmits (transfers) the suspended load image, which has been received from the second support device 200, to the first support device 100.

The first support device 100, which has received the suspended load image from the management device 400, causes the first display device DS1 to display the suspended load image so that the work supporter EX can view the suspended load image. Then, the work supporter EX who has viewed the suspended load image touches the position of the suspended load image, which is suspected of being the center of gravity of the suspended load SL, with a finger to determine the position at which work support information SG is to be displayed. In the illustrated example, the work support information SG is a graphical image (circular image) indicating the position of the center of gravity of the suspended load SL, and is displayed to be in a position inside the suspended load SL, which is not visible in reality.

The first client-side controller CR1 may generate a three-dimensional model of the suspended load SL using a plurality of images of the suspended load SL captured from multiple viewpoints and a known three-dimensional reconstruction technique. The three-dimensional reconstruction technique is a technique of estimating three-dimensional information from two-dimensional images captured by the imaging device CM, and includes, for example, photogrammetry, neural radiance fields (NeRF), and the like. The work supporter EX may determine one point (two-dimensional coordinates) in the image of the suspended load SL corresponding to the center of gravity of the suspended load SL based on the three-dimensional model. Specifically, the work supporter EX may determine a position at which the work support information SG is displayed after viewing the three-dimensional model of the suspended load SL from arbitrary directions. In this case, the work supporter EX may perform fine adjustments of the position, at which the work support information SG is displayed, using various graphical user interfaces (GUIs) provided by the first support device 100.

Then, the information related to the position of the center of gravity of the suspended load SL specified by the work supporter EX (center of gravity position information) is transmitted to the second support device 200, and the second support device 200 superimposes and displays the work support information SG at an appropriate position of the image displayed on the second display device DS2 (the image captured by the second imaging device CM2). The work support information SG is not limited to the graphical image indicating the position of the center of gravity of the suspended load SL, and may be a graphical image indicating a position at which the hook 7 is to be positioned (typically a position directly above the center of gravity of the suspended load SL) or a graphical image indicating a position of the suspended load SL at which the sling wire SW is to be attached.

The slinging worker WK can check the position of the center of gravity of the suspended load SL provided by the work supporter EX by viewing the work support information SG displayed on the second display device DS2. Thus, the slinging worker WK can give an instruction to the on-board operator VP of the work machine 300, for example, to move the hook 7 to the position directly above the center of gravity of the suspended load SL using the communication device TD or the like. Specifically, the slinging worker WK sends information, such as “Please move the hook 7 by 30 cm to the right and 30 cm backward”, to the on-board operator VP of the work machine 300, thereby guiding the hook 7 to the position directly above the center of gravity of the suspended load SL. The “to the right” and “backward” are both directions as viewed from the slinging worker WK. The same applies to “left”, “forward”, “up”, and “down”, which will be the same in the following description. In addition, the work supporter EX may give an instruction to the on-board operator VP of the work machine 300 using the communication device TD or the like, as necessary.

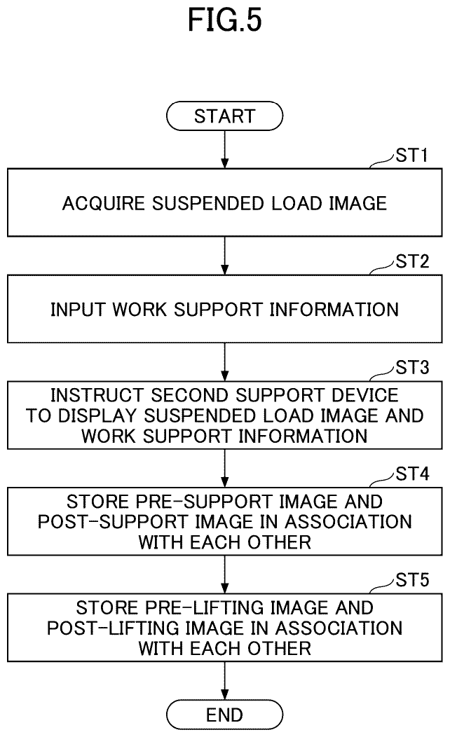

Next, another example of the slinging work support process will be described with reference to FIG. 5. FIG. 5 is a flowchart illustrating another example of the flow of the slinging work support process. The slinging work support process illustrated in FIG. 5 is different from the slinging work support process illustrated in FIG. 3 in that the slinging work support process illustrated in FIG. 5 further includes step ST4 and step ST5, which are performed after step ST3, but other aspects of the slinging work support process illustrated in FIG. 5 are same as the slinging work support process illustrated in FIG. 3. Thus, the description of the common features will be omitted, and only different features will be described in detail hereinafter.

After instructing the second support device 200 to display the suspended load image and the work support information, the first client-side controller CR1 stores a pre-support image and a post-support image in association with each other (step ST4) so that the details of the support provided by the work supporter EX can be validified, or the machine learning part ML can perform machine learning of the details of the support provided by the work supporter EX. The pre-support image is an image illustrating a state of the suspended load SL before the support is provided by the work supporter EX. The post-support image is an image illustrating a state of the suspended load SL after the support is provided by the work supporter EX.

Specifically, in the case where the slinging worker WK requests the work supporter EX to check after independently attaching the sling wire SW to the suspended load SL, the sling wire SW is already attached to the suspended load SL at the time when the work supporter EX inputs work support information SG. In this case, the pre-support image is, for example, an image captured by the second imaging device CM2 before the work supporter EX inputs the work support information SG, and includes the image of the suspended load SL and the image of the sling wire SW at that point. The pre-support image may include the image of the hook 7. On the other hand, the post-support image is an image illustrating the state of the suspended load SL after the change, when the slinging worker WK has changed the arrangement of the sling wire SW, the length of the sling wire SW, the position of the hook 7, or the like, based on the position of the center of gravity of the suspended load SL or the like provided by the work supporter EX. In the case where the slinging worker WK has not changed the arrangement of the sling wire SW, the length of the sling wire SW, the position of the hook 7, or the like after the support is provided by the work supporter EX, the components of the post-support image are the same as the components of the pre-support image. The first client-side controller CR1 stores, for example, the suspended load image acquired at step ST1 as the pre-support image, and stores, as the post-support image, the image captured by the second imaging device CM2 when lifting of the hook 7 is started by the work machine 300.

Then, the first client-side controller CR1 stores a pre-lifting image and a post-lifting image in association with each other (step ST5) so that the details of the support provided by the work supporter EX can be validified or the machine learning part ML can perform machine learning of the details of the support provided by the work supporter EX. The pre-lifting image is an image illustrating a state of the suspended load SL before lifting the suspended load SL. The post-lifting image is an image illustrating a state of the suspended load SL after lifting the suspended load SL. In addition, the lifting of the suspended load SL means separation (lifting off) of the suspended load SL from an installation surface IS (the ground on which the suspended load SL is placed).

Specifically, the pre-lifting image is an image captured by the second imaging device CM2 after the hook 7 to which the sling wire SW is suspended starts to rise and before the suspended load SL is lifted off, and includes images of the suspended load SL, the sling wire SW, and the hook 7, respectively, at that point. On the other hand, the post-lifting image is an image captured by the second imaging device CM2 after the suspended load SL is separated from the installation surface IS, and includes images of the suspended load SL, the sling wire SW, and the hook 7, respectively, at that point.

The components of the pre-lifting image are typically the same as the components of the post-support image. The components of the pre-lifting image include, for example, the arrangement of the sling wire SW, the length of the sling wire SW, the position of the hook 7, or the like. Thus, the first client-side controller CR1 stores the pre-support image and the post-support image in association with each other, and may store the pre-support image, the post-support image, and the post-lifting image in association with one another, instead of storing the pre-lifting image and the post-lifting image in association with each other.

With the above processing, the first client-side controller CR1 can collect the data for verifying the details of the support provided by the work supporter EX every time the work supporter EX supports the slinging work performed by the slinging worker WK. Alternatively, the first client-side controller CR1 can collect sample data for the machine learning part ML to perform machine learning of the details of the support provided by the work supporter EX every time the work supporter EX supports the slinging work performed by the slinging worker WK. In addition, the first client-side controller CR1 can perform various determinations regarding the suspended load SL. Specifically, the first client-side controller CR1 can determine whether or not the slinging worker WK has changed the arrangement of the sling wire SW, the length of the sling wire SW, the position of the hook 7, or the like based on the work support information SG by comparing the pre-support image and the post-support image. In addition, the first client-side controller CR1 can determine whether or not the swinging, dropping, or the like of the suspended load SL (referred to as “load-swing or the like” hereinafter) has occurred when the suspended load SL is lifted off the ground by comparing the pre-lifting image and the post-lifting image. Further, before the suspended load SL is lifted off the ground, the first client-side controller CR1 can determine whether or not the load-swing or the like of the suspended load SL occurs when the suspended load SL is lifted off the ground based on the pre-lifting image and the machine learning model.

In the case where the machine learning result of the machine learning part ML can be used, before providing the work support information to the slinging worker WK, the work supporter EX may check whether or not occurrences of load-swing or the like can be prevented by the work support information SG input by the work supporter EX. Alternatively, the work supporter EX may determine the display position of the work support information SG with reference to the arrangement of the sling wire SW, the length of the sling wire SW, the position of the hook 7, or the like simulated by the machine learning part ML based on the shape of the like of the suspended load SL.

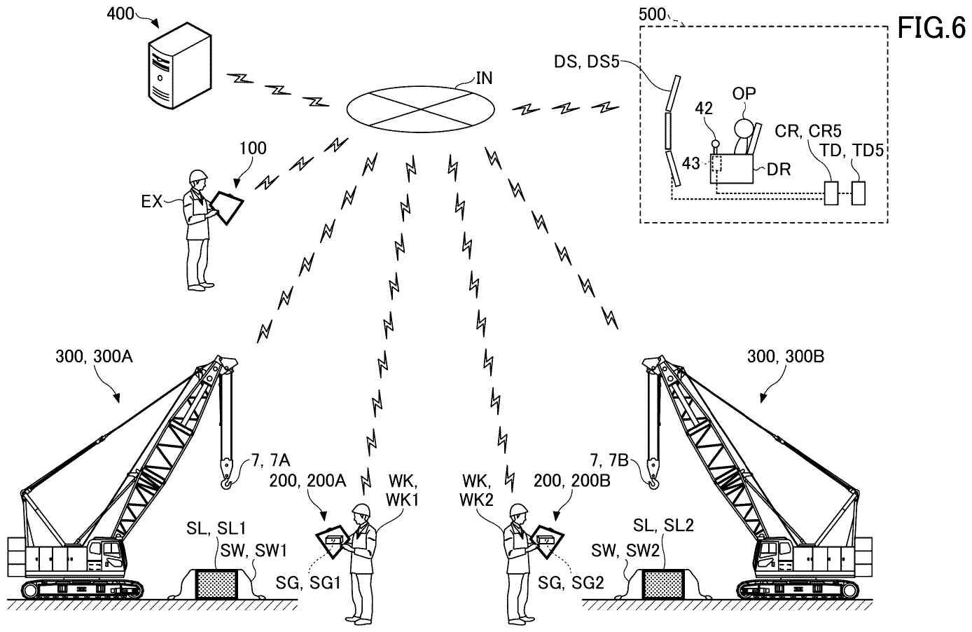

Next, another configuration example of the slinging work support system SYS will be described with reference to FIG. 6. FIG. 6 is a schematic view illustrating another configuration example of the slinging work support system SYS. The slinging work support system SYS illustrated in FIG. 6 is different from the slinging work support system SYS illustrated in FIG. 1 in that the slinging work support system SYS illustrated in FIG. 6 includes one first support device 100, two second support devices 200 (second support device 200A and second support device 200B), two work machines 300 (work machine 300A and work machine 300B), one management device 400, and one remote operation device 500. However, the slinging work support system SYS illustrated in FIG. 6 is the same as the slinging work support system SYS illustrated in FIG. 1 in other aspects. Thus, the description of the common features will be omitted, and the different features will be described in detail hereinafter.

Two work machines 300 (work machine 300A and work machine 300B) located at positions separated from each other are sequentially operated by one remote operator OP who operates a remote operation device 500. Specifically, the remote operator OP can operate the two work sites. A second support device 200A is a tablet PC carried by a slinging worker WK1 who performs slinging work of a suspended load SL (suspended load SL1) to be lifted by the work machine 300A. A second support device 200B is a tablet PC carried by a slinging worker WK2 who performs slinging work of a suspended load SL (suspended load SL2) to be lifted by the work machine 300B.

The remote operation device 500 is a device installed at a location away from the first work site in which the work machine 300A is located, and is also away from the second work site in which the work machine 300B is located. The remote operation device 500 is also referred to as a remote operation room. Specifically, the remote operator OP remotely operates the work machines 300 from the location away from any of the work sites. Similarly, the work supporter EX supports the slinging work performed by the slinging workers WK from a location that is away from all of the work sites and is away from the remote operation device 500. In addition, the first work site and the second work site are located far away from each other.

The remote operation device 500 includes an operation device 42, an operation sensor 43, a controller CR (remote controller CR5), a display device DS (fifth display device DS5), a communication device TD (fifth communication device TD5), and the like. In addition, the remote operation device 500 includes an operating seat DR in which a remote operator OP who remotely operates both the work machine 300A and the work machine 300B is seated.

The fifth communication device TD5 is configured to control communication with the communication devices TD attached to the work machines 300.

The remote controller CR5 is yet another example of processing circuitry serving as the controller CR, and is configured by a computer including a CPU, a RAM, a ROM, a non-volatile storage device, and the like. The remote controller CR5 reads a program corresponding to each of functional elements from the ROM, loads the program into the RAM, and causes the CPU to execute corresponding processing. However, each functional element may be configured by hardware, or may be configured by a combination of software and hardware.

The fifth display device DS5 displays a screen based on the information transmitted from each work machine 300 so that the remote operator OP can visually recognize the surroundings of each work machine 300. The information transmitted from each work machine 300 is, for example, an image captured by one or more imaging devices attached to each work machine 300. The remote operator OP can check the situation of the work site including the surroundings of each work machine 300 by viewing the image displayed on the fifth display device DS5. In the illustrated example, the fifth display device DS5 is a liquid crystal display, but may be extended reality (XR) goggles or the like.

The operation device 42 is a device used by the remote operator OP to operate the actuator mounted on each work machine 300. The actuator includes a hydraulic actuator or an electric actuator, or both a hydraulic actuator and an electric actuator. In the illustrated example, the operation device 42 includes an operation lever, a travel lever, and a travel pedal. The operation lever includes a slewing operation lever, a boom operation lever, and a hook lifting lever.

An operation sensor 43 is provided to the operation device 42, and the operation sensor 43 detects the operation details of the operation device 42. The operation sensor 43 is, for example, an inclination sensor that detects an inclination angle of the operation lever, an angular sensor that detects a slewing angle about a slewing axis of the operation lever, or the like. The operation sensor 43 may be configured by another sensor, such as a pressure sensor, a current sensor, a voltage sensor, a distance sensor, or the like. The operation sensor 43 outputs information regarding the detected operation details of the operation device 42 to the remote controller CR5. The remote controller CR5 generates an operation signal based on the received information, and transmits the generated operation signal to a corresponding work machine 300. Thus, the remote operator OP can remotely operate each work machine 300 using the remote operation device 500.

In the example illustrated in FIG. 6, once the management device 400 receives a support request signal from the second support device 200A carried by the slinging worker WK1, the management device 400 transfers the support request signal to the first support device 100 carried by the work supporter EX.

Then, the first support device 100 transmits an image request signal to the second support device 200A to acquire an image of the suspended load SL1 (first suspended load image). The second support device 200A, which has received the image request signal, causes the second display device DS2 to display a text image, such as “Please capture an image of the suspended load”, to encourage the slinging worker WK1 to capture a first suspended load image.

The second support device 200A, which has acquired the first suspended load image, transmits the first suspended load image to the first support device 100. The first support device 100 causes the first display device DS1 to display the received first suspended load image, and encourages the work supporter EX to input work support information SG (work support information SG1). The work supporter EX inputs the work support information SG1 to transmit the work support information SG1 to the second support device 200A.

The second support device 200A, which has received the work support information SG1, superimposes and displays the work support information SG1 over the image of the suspended load SL1 displayed on the second display device DS2. After the slinging worker WK1 checks the work support information SG1, the slinging worker WK1 attaches the suspended load SL1 to one end of the sling wire SW (sling wire SW1).

In addition, the slinging worker WK1 makes a request to an operation of the work machine 300A to the remote operator OP via the communication device TD. Specifically, the slinging worker WK1 makes a request to the remote operator OP to move the hook 7 (hook 7A) to the desired position. The work supporter EX may make a request to the remote operator OP to perform a necessary operation, as necessary. For example, in the case where the work supporter EX judges that the slinging worker WK1 is requesting an incorrect operation to the remote operator OP, the work supporter EX may make a request to the remote operator OP to cancel such operation. The remote operator OP who has received the request from the slinging worker WK1 remotely operates the work machine 300A via the communication device TD to position the hook 7A at the position suggested by the slinging worker WK1.

Then, the slinging worker WK1 hooks the other end of the sling wire SW1 on the hook 7A, brings the suspended load SL1 into a ready state, and makes a request to the remote operator OP to lift the hook 7A. The ready state of the suspended load SL1 is, for example, a state in which one end of the sling wire SW1 is attached to the suspended load SL1 and the other end of the sling wire SW1 is hooked on the hook 7A, i.e., a state in which preparation for being lifted by the hook 7A is completed. Thereafter, when the suspended load SL1 is lifted off without causing load-swing or the like, the slinging worker WK1 makes a request to the remote operator OP to transport the suspended load SL1 to a desired target position. In the manner described above, the slinging worker WK1 can achieve the transportation of the suspended load SL1.

Then, once the management device 400 receives a support request signal from the second support device 200B carried by the slinging worker WK2, the management device 400 transfers the support request signal to the first support device 100 carried by the work supporter EX in the same manner as when the management device 400 receives a support request signal from the second support device 200A. The subsequent flow of the work is also the same as that in the case where the support request signal from the second support device 200A is received.

Specifically, the first support device 100 transmits an image request signal to the second support device 200B to acquire an image of the suspended load SL2 (second suspended load image). The second support device 200B, which has received the image request signal, causes the second display device DS2 to display a text image, such as “Please capture an image of the suspended load”, to encourage the slinging worker WK2 to capture a second suspended load image.

The second support device 200B, which has acquired the second suspended load image, transmits the second suspended load image to the first support device 100. The first support device 100 causes the first display device DS1 to display the received first suspended load image, and encourages the work supporter EX to input work support information SG (work support information SG2). The work supporter EX inputs the work support information SG2 to transmit the work support information SG2 to the second support device 200B.

The second support device 200B, which has received the work support information SG2, superimposes and displays the work support information SG2 over the image of the suspended load SL2 displayed on the second display device DS2. After the slinging worker WK2 checks the work support information SG2, the slinging worker WK2 attaches the suspended load SL2 to one end of the sling wire SW (sling wire SW2).

In addition, the slinging worker WK2 makes a request for an operation of the work machine 300B to the remote operator OP via the communication device TD. Specifically, the slinging worker WK2 makes a request to the remote operator OP to move the hook 7 (hook 7B) to the desired position. The remote operator OP who has received the request from the slinging worker WK2 remotely operates the work machine 300B via the communication device TD to position the hook 7B at the position suggested by the slinging worker WK2.

Then, the slinging worker WK2 hooks the other end of the sling wire SW2 on the hook 7B, brings the suspended load SL2 into a ready state, and makes a request to the remote operator OP to lift the hook 7B. Thereafter, when the suspended load SL2 is lifted off without causing load-swing or the like, the slinging worker WK2 makes a request to the remote operator OP to transport the suspended load SL2 to a desired target position. In the manner described above, the slinging worker WK2 can achieve the transportation of the suspended load SL2.

In the above-described manner, use of the slinging work support system SYS illustrated in FIG. 6 allows one work supporter EX to sequentially support the slinging work performed at multiple work sites, while the work supporter EX is at a remote location. Similarly, the remote operator OP can sequentially remotely operate the work machines 300 installed at the multiple work sites, while the remote operator OP is at a remote location. Thus, both the slinging worker WK1 at the first work site and the slinging worker WK2 at the second work site can safely and efficiently proceed with the slinging work using experience and knowledge of the work supporter EX, who is a skilled worker, in a remote location. In addition, both the slinging worker WK1 in the first work site and the slinging worker WK2 in the second work site can safely and efficiently proceed with the slinging work using the operation technique of the remote operator OP who is a skilled operator at a remote location. The remote operator OP and the work supporter EX may be the same person.

As described above, the slinging work support system SYS for supporting slinging work of a suspended load SL according to the embodiment of the present disclosure includes, as illustrated in FIG. 1, an imaging device CM configured to capture an image of the suspended load SL, a first display device DS1 which is visible to a work supporter EX at a position away from a slinging worker WK who performs the slinging work, a second display device DS2 which is visible to the slinging worker WK, a first input device ID1 used when the work supporter EX inputs work support information for supporting the slinging work performed by the slinging worker WK, and a controller CR that causes the second display device DS2 to display the work support information input via the first input device ID1 together with the image captured by the imaging device CM.

According to the above configuration, the slinging work support system SYS can support the slinging work performed by a non-skilled slinging worker WK, for example, by allowing the slinging worker WK to view the work support information presented by the work supporter EX who is a skilled slinging worker. Specifically, for example, even in a case where the suspended load SL has a complicated shape and it is difficult to determine the position of the center of gravity of the suspended load SL at a glance, the slinging worker WK can consult the work supporter EX about the position of the center of gravity of the suspended load SL. Therefore, for example, even in the case where the slinging worker WK is inexperienced in slinging work, the slinging worker WK can accurately perform slinging work by hooking the sling wire SW to the hook 7 that is positioned directly above the position of the center of gravity of the suspended load SL. Specifically, the slinging worker WK can appropriately determine the position of the hook 7 to which the sling wire SW is hooked using the experience, skill, know-how, knack, and the like of the work supporter EX. As a result, the slinging work support system SYS allows the suspended load SL to be lifted in the state in which the weight balance of the suspended load SL is maintained, thereby demonstrating an effect of preventing occurrences of load-swing, fall, and the like during transportation. In addition, the slinging worker WK can reduce the repetition of complicated work, such as fine adjustments of the attachment position of the sling wire SW or the position of the hook 7 performed by repeating a process of slight lifting and lowering of the suspended load SL. Since the work supporter EX can support the slinging worker WK from a remote location, the work supporter EX can effectively support a plurality of slinging workers WK at multiple work sites. Specifically, the work supporter EX can oversee multiple work sites.

In addition, the slinging work support system SYS may include a first communication device TD1 used by the work supporter EX and a second communication device TD2 used by the slinging worker WK. The controller CR may be configured to cause the second display device DS2 to display the work support information together with the image captured by the imaging device CM in a state in which audio communication is established between the first communication device TD1 and the second communication device TD2.

According to the above configuration, the work support information set by the work supporter EX can be viewed by the slinging worker WK on the second display device DS2, while communicating with the work supporter EX through audio communication. Accordingly, the slinging worker WK can more accurately understand the support provided by the work supporter EX, compared with a case where no audio communication is used. Specifically, the slinging worker WK can proceed with the slinging work while viewing the same image as the work supporter EX and having a discussion with the work supporter EX as in a Web meeting. In addition, the slinging worker WK can proceed with the slinging work while viewing the same image with the work supporter EX and the on-board operator VP of the work machine 300 and having a discussion with the work supporter EX and the on-board operator VP of the work machine 300 as in a Web meeting.

The slinging work support system SYS may further include a third display device DS3 that is visible to an on-board operator VP who operates a work machine 300 that lifts the suspended load SL. The first input device ID1 may be used when the work supporter EX inputs operation support information for supporting operation of the work machine 300 performed by the on-board operator VP of the work machine 300. Further, the controller CR may be configured to cause the third display device DS3 to display the operation support information input via the first input device ID1 together with the image captured by the imaging device CM. Specifically, the work supporter EX may support the on-board operator VP of the work machine 300 by inputting the operation support information corresponding to the work support information, in the same manner as the case where the work supporter EX supports the slinging worker WK.

According to the above configuration, the slinging work support system SYS can support the operation of the work machine 300 performed by the on-board operator VP by presenting a non-skilled on-board operator VP the operation support information provided by the work supporter EX who is a skilled operator. Specifically, for example, even if the on-board operator VP of the work machine 300 is inexperienced in operation of the work machine 300, the on-board operator VP can accurately position the hook 7 directly above the position of the center of gravity of the suspended load SL.

The controller CR may be configured to store a pre-lifting image and a post-lifting image in association with each other, where the pre-lifting image depicts the suspended load SL and the hook 7 that lifts the suspended load SL when lifting of the suspended load SL is started after displaying the work support information SG on the second display device DS2, as illustrated in FIG. 4, and the post-lifting image depicts the suspended load SL and the hook 7 when the suspended load SL is then lifted off from the ground.

According to the above configuration, the slinging work support system SYS can record, as a history, how the slinging worker WK has responded to the advice of the work supporter EX or how accurately the slinging worker WK has responded to the advice of the work supporter EX. Specifically, the slinging work support system SYS can record, for example, as a history, whether or not the slinging worker WK has moved the position of the hook 7 based on the advice of the work supporter EX. Accordingly, the above configuration enables later verification, such as whether or not the support of the work supporter EX regarding the position of the hook 7 was appropriate, whether or not the slinging work performed by the slinging worker WK who received the support was appropriate, or the like, which leads to an effect of improving the support from the work supporter EX or the like. In addition, the above configuration brings about an effect of realizing machine-learning of the details of the support provided by the work supporter EX.

The controller CR may be configured to store a pre-lifting image and a post-lifting image in association with each other, where the pre-lifting image depicts the suspended load SL and a sling wire SW attached to the suspended load SL when lifting of the suspended load SL is started after displaying the work support information SG on the second display device DS2 as illustrated in FIG. 4, and the post-lifting image depicts the suspended load SL and the sling wire SW when the suspended load SL is then lifted off from the ground.

According to the above configuration, the slinging work support system SYS can record, as a history, for example, whether or not the slinging worker WK has changed the arrangement, length, or the like of the sling wire SW based on the advice of the work supporter EX. Therefore, the above configuration enables later verification concerning whether or not the support of the work supporter EX regarding the arrangement, length, or the like of the sling wire SW was appropriate, whether or not the slinging work performed by the slinging worker WK who received the support was appropriate, or the like, leading to an effect of improving the support from the work supporter EX or the like. In addition, the above configuration brings about an effect of realizing machine-learning of the details of the support provided by the work supporter EX.

The image captured by the imaging device CM may include an image depicting an upper surface of the suspended load SL and an image depicting a side surface of the suspended load SL.

The above configuration brings about an effect of enhancing effectiveness of the support provided by the work supporter EX. This is because the work supporter EX can provide more appropriate support, as the suspended load image is more appropriate. For example, in the case where an image viewed from the viewpoint where the position of the center of gravity of the suspended load SL is easily determined, the work supporter EX can more accurately determine the position of the center of gravity of the suspended load SL compared to the case where the image viewed from the viewpoint where the position of the center of gravity of the suspended load SL is easily determined cannot be used.

The slinging work support program according to the embodiment of the present disclosure is a program for causing a computer to perform a method of supporting slinging work of a suspended load SL. The program is configured to cause a computer to perform the method including: causing an imaging device CM to capture an image of the suspended load SL; causing a first display device DS1 to display the image captured by the imaging device CM, where the first display device DS1 is visible to a work supporter EX who is at a position away from a slinging worker WK who performs the slinging work; causing a second display device DS2 to display the image captured by the imaging device CM, where the second display device DS2 is visible to the slinging worker WK; allowing the work supporter EX to input work support information SG for supporting the slinging work performed by the slinging worker WK via a first input device ID1; and causing the second display device DS2 to display the work support information SG input via the first input device ID1 together with the image captured by the imaging device CM.

The above program brings about an effect that the work supporter EX can support the slinging work performed by the slinging worker WK, for example, by allowing a non-skilled slinging worker WK to view the work support information provided by the work supporter EX who is a skilled slinging worker.

In the above-described embodiment, the work machine 300 is a mobile crane, but may be a fixed crane. In addition, the work machine 300 may be a shovel (excavator) having a crane function. Specifically, the work machine 300 may be a shovel equipped with a hook that is housed on the back side of the bucket. Further, the slinging work support system SYS may not include the work machine 300 or the management device 400, or not include both the work machine 300 and the management device 400. For example, the slinging work support system SYS may be configured by a combination of the first support device 100, the second support device 200, and the management device 400. Alternatively, the slinging work support system SYS may be configured by a combination of the first support device 100, the second support device 200, and the work machine 300. Further, the slinging work support system SYS may be configured by a combination of the first support device 100 and the second support device 200.

In the above-described embodiment, the slinging work support system SYS is configured to support the slinging work when the suspended load SL is lifted by the hook 7 of the work machine 300, but the slinging work support system SYS may be configured to support slinging work when the suspended load SL is lifted using a chain block, such as a manual chain block, an electric chain block, or the like.

Although the embodiments of the present disclosure have been described above, the present disclosure is not limited to the above-described embodiments. Various modifications, substitutions, and the like may be applicable to the embodiments described herein without departing from the scope of the present invention. In addition, the individually described features may be appropriately combined as long as there is no technical contradiction.

What is claimed is:

1. A slinging work support system for supporting slinging work of a suspended load, the slinging work support system comprising:
an imaging device configured to capture an image of the suspended load;
a first display device that is visible to a work supporter who is at a position away from a slinging worker who performs the slinging work;
a second display device that is visible to the slinging worker;
a first input device that is used when the work supporter inputs work support information for supporting the slinging work performed by the slinging worker; and
a controller including a processor and a storage device coupled to the processor, the controller configured to cause the second display device to display the work support information input via the first input device together with the image captured by the imaging device.

2. The slinging work support system according to claim 1, further comprising:
a first communication device used by the work supporter; and
a second communication device used by the slinging worker,
wherein the processor causes the second display device to display the work support information together with the image captured by the imaging device, in a state in which audio communication is established between the first communication device and the second communication device.

3. The slinging work support system according to claim 1, further comprising:
a third display device that is visible to an operator who operates a work machine that lifts the suspended load,
wherein the first input device is used when the work supporter inputs operation support information for supporting an operation of the operator, and
the processor causes the third display device to display the operation support information input via the first input device together with the image captured by the imaging device.

4. The slinging work support system according to claim 1,
wherein the processor causes storing of a pre-lifting image and a post-lifting image in association with each other, where the pre-lifting image depicts the suspended load and a hook lifting the suspended load when lifting of the suspended load is started after displaying the work support information on the second display device, and the post-lifting image depicts the suspended load and the hook when the suspended load is lifted off from the ground.

5. The slinging work support system according to claim 1,
wherein the processor causes storing of a pre-lifting image and a post-lifting image in association with each other, where the pre-lifting image depicts the suspended load and a sling wire attached to the suspended load when lifting of the suspended load is started after displaying the work support information on the second display device, and the post-lifting image depicts the suspended load and the sling wire when the suspended load is lifted off from the ground.

6. The slinging work support system according to claim 1,
wherein the image captured by the imaging device includes an image depicting an upper surface of the suspended load, an image depicting a side surface of the suspended load, or both of the image depicting the upper surface of the suspended load and the image depicting the side surface of the suspended load.

7. A non-transitory computer-readable storage medium having programs stored thereon, wherein the programs, when executed by a computer, are configured to cause the computer to perform a method of supporting slinging work of a suspended load, the method comprising:
causing an imaging device to capture an image of the suspended load;
causing a first display to display the image captured by the imaging device, the first display device being visible to a work supporter who is at a position away from a slinging worker who performs the slinging work;
causing a second display to display the image captured by the imaging device, the second display device being visible to the slinging worker;
allowing the work supporter to input work support information for supporting the slinging work performed by the slinging worker via a first input device; and
causing the second display device to display the work support information input via the first input device together with the image captured by the imaging device.
